(19) United States
(12) Patent Application Publication
(10) Pub. No.: US 2024/0009873 A1
(43) Pub. Date: Jan. 11, 2024

(54) BLADE UNIT FOR A WET RAZOR

(71) Applicant: LORD INTERNATIONAL CO., Alexandria (EG)

(72) Inventors: Mohamed SOLIMAN, Alexandria (EG); Florian WITT, Wentorf (DE)

(21) Appl. No.: 18/037,796

(22) PCT Filed: Nov. 18, 2021
(86) PCT No.: PCT/EP2021/082098

§ 371 Date: May 19, 2023

(30) Foreign Application Priority Data
Nov. 20, 2020 (DE) 10 2020 130 698.9

(51) Int. Cl. B26B 21/22; B26B 21/40; B26B 21/56

(52) U.S. Cl. CPC B26B 21/222; B26B 21/4012; B26B 21/565

(57) ABSTRACT

The invention relates to a blade unit (01) for a wet razor comprising a support frame (02), which has an inner face and an outer face oriented towards a shaving plane and in which a plurality of elongate blades (03) are arranged. The support frame (02) has two opposing side portions (07) which extend transversely with respect to the cutting edges (04) of the blades (03). A plurality of parallel supports (09) extend between the side portions (07), between which supports an open space (11) remains. Each of the blades (03) is mounted to the inner face of the head portion (12) of one of the supports (09) so that the cutting edge (04) lies in the open space (11). The invention also relates to a wet razor comprising a handle and a blade unit (01) fastened directly or indirectly thereto.

### BACKGROUND OF THE INVENTION

The present invention relates to a blade unit for a wet razor. Furthermore, the invention relates to a wet razor with this blade unit.

Known razor blade units for wet shaving consist most often of two or more frame parts, with the slide strip on one frame part and the foam edge on the other frame part. In older units, the blades were riveted into the frame. As the number of blades increases, rivet fastening is disadvantageous, since the distance between the rivet holes and the cutting tip increases considerably with each blade. The blades must therefore be of different widths, which in the case of three or more blades leads to very wide cutting units. A separate blade geometry is required for each blade position.

U.S. Pat. No. 4,378,634 discloses a shaving blade unit in which the blades can move up and down in slots in a housing against spring finger biasing means during shaving. Metal caps arranged on the housing hold the blades in the slots and determine the positions of the cutting edges of the blades in the rest position. During manufacture, the blades are initially arranged in the housing. Subsequently, a U-shaped cap is positioned over the housing and the blades. In a final step, the legs of the cap are bent around the lower part of the housing.

DE 698 16 635 T2 describes a razor unit having a metal retaining clip for retaining blades. The housing has a first lever portion extending outwardly over adjacent surface portions on two sides of the lever portion. The retaining clip includes a first end portion that has been bent over the first lever portion beyond the elastic limit of the clip. As the first end piece is bent about the first lever portion piece, the lever portion piece is deformed by the applied pressure and reduced in height.

The blades of the razor blade units are typically milled from narrow steel strips. Since steel is a relatively expensive material, efforts are made to use the smallest possible strip widths. To ensure that the razor blade unit can be rinsed out easily, which is to say, it is possible to clear the spaces between adjacent blades, angled blades are generally used for units with three or more blades. The use of angled blades has been known for a long time and can be found, for example, in EP 0 064 190, DE 25 18 499 and U.S. Pat. No. 4,302,876.

In general, an substantial requirement for shaving blade units is to precisely position the cutting edges of the multiple blades in relation to each other and in relation to the contact plane of the skin. The more blades are used in the shaving blade unit, the more demanding this positioning is. If the cutting edges of one or more blades are not precisely aligned, there is either a risk of injury to the user or the shaving result is not optimal. The problem of precise positioning of the cutting edges is also the subject of numerous earlier patent documents.

For example, JP 2011-160818 A describes a razor having a plurality of blades and a guard extending in the longitudinal direction of the blades. The blades are borne by a common cage-like support.

EP 3 075 498 A1 describes a razor head having a blade unit comprising a plurality of blades and a base member, which base member is arranged at the rear side of the blades. The base member has a support surface formed through the deformation of a steel plate. The support surface includes mounting surfaces and a cage-shaped support portion. An additional blade fastening plate includes a plurality of step plates, which step plates match the blade fastening portions, and bridge portions which connect the step plates together. Reinforcement plate portions are respectively bent from the step plates to the inside of the blade unit. The step plates, the reinforcing plate portions and the bridge portions are formed as one piece with each other. Each blade is fastened to the associated step plate via a plurality of weld points.

EP 2 279 062 B1 describes a razor blade unit having a housing, a guard which is arranged at a front portion of the housing, a cap which is arranged at a rear portion of the housing, and a plurality of blades each including a sharp upper edge and a lower portion having a front side and a rear side. Each blade has a blade support which is mounted between a plurality of pins, which support is preferably made of polymer.

EP 1 990 143 B1 discloses a shaving head having a blade body comprising a blade element, a blade base element and an upper element. The blade element is fastened between the blade base element and the upper element. The cutting edge of the blade body is exposed in the upper element. The base is resiliently retained on the blade base element, in order to be movable against a pressing load from the skin surface. The base is provided with an attachment base which is mounted on the blade base element, and a blade body holding portion which is formed between a pair of attachment bodies. A flat spring is mounted on both attachment bodies. The blade body holding portion is provided with a plurality of blade body fixing portions arranged in a step pattern, wherein each of the blade bodies is movable as one piece together with each of the blade body fixing portions.

DE 27 50 196 A1 describes a head part for a shaver. A plurality of razor blades are respectively secured at their ends in an open housing frame. The cutting edges extend at a predetermined distance from a protective surface of the housing frame. Support surfaces are provided above the housing frame for securing the blades, wherein the support surfaces extend in a step-like manner and bear the blades on the surface facing the shaving plane.

WO 2017/161341 A1 describes a razor cartridge having a one-piece inner blade frame for retaining a plurality of blades. The blade frame has several angled joints which connect at least three protective elements (guards). This results in a step-like progression of the side edges of the blade frame. A razor blade is respectively mounted to the underside of the extensions of the protective elements, the cutting edge of which razor blade extends into a gap between adjacent protective elements.

From all previously known designs of so-called wet razor cartridges, which is to say, exchangeable razor head units, conflicting requirements arise from the desired high precision of the blade positioning on the one hand and the cheapest and simplest possible construction of the cartridges on the other.

One task of the present invention is therefore to provide an improved blade unit for a wet razor, in which high positioning accuracy is ensured with respect to the cutting edges of the blades and which at the same time has a very simple construction requiring only a few individual parts. The blade unit should also be characterized by a relatively low assembly complexity and thus the lowest possible manufacturing costs. Lastly, the invention is intended to provide an improved wet shaver.

A blade unit according to the appended claim 1 and a wet razor according to claim 13 serve to solve the task according to the invention.

The blade unit for a wet razor according to the invention has a support frame with an outer face which is oriented towards the shaving plane during use, which is to say, comes into contact with the skin surface of the user and with an inner face. The blade unit moreover comprises a plurality of elongate blades (also called main blades) which are positioned in the support frame and which have a cutting edge extending transversely with respect to a shaving direction.

The support frame of the blade unit has two opposing side portions which extend transversely with respect to the cutting edges of the blades. Several parallel supports run between the side portions, between which supports an open space remains. Each support has a head portion and a thereto angled base portion. One of the blades is mounted to each support, namely on the inside of the head portion. This is a significant difference to many previously known blade units, where the blades are regularly mounted on the outward facing side of support surfaces. In the configuration according to the invention, the cutting edge of each blade is also located in the open space between adjacent supports and extends from the inside of the blade unit towards the outside. This leads to the particular advantage that during the shaving process a better, more rigid support of the blade is provided, inasmuch as the force components occurring during the cutting of the hair press the blade against the inside of the head portion of the support, so that the blade comes into contact with the latter and is not lifted off the support. The unsupported width of the blade that remains in the cutting moment is thus smaller than if the blade were fastened to the outside of the support. Surprisingly, this leads to a better shaving result and above all to a longer service life of the blades, since the cutting edges of the blades are deformed less during shaving.

Preferably, the opposing side portions of the support frame are flat shaped, without step formation or similar profiling. The flat side portions thereby span a reference surface that corresponds to the shaving plane and preferably does not show any curvature. The cutting edges of the plurality of blades are particularly preferably positioned in this shaving plane, wherein in special embodiments for individual blades, a small protrusion or even a small exposure from the shaving plane can be adjusted.

The blades are preferably welded to the respective head portion of the support. Particularly preferably, a plurality of welding points per blade which are spaced out from one another are set for this purpose by a laser welding process. The fact that the blades are only fastened to the head portion of the support at certain points is not critical, since the blade is pressed flat against the support during shaving.

The open spaces between the supports run largely parallel to the cutting edge located there. In a respective limit stop portion, which starts at the side portions of the support frame, the open spaces do however run at an acute angle to the cutting edge. In this manner, a first embodiment enables the cutting edges of the blades to come into contact with a cutting edge limit stop at each of their two ends in the associated limit stop portion. The cutting edge limit stop is formed as a projection which rises into the interior of the blade unit at a portion of the support extending at an acute angle to the cutting edge. Preferably, the projection is formed as one piece with the support, for example, by a one-sided cut-out of the support in the limit stop portion and the bending out of a triangular projection so that one side edge of the triangular projection runs parallel with the cutting edge and acts as a limit stop edge for the cutting edge. In this, the projection protrudes beyond the surface of the support in the direction of the interior of the blade unit by only about the thickness of the blade. The limit stop edge preferably has a length of between 0.5 mm and 3 mm.

According to a modified embodiment, the correct positioning of the cutting edges is achieved without the previously mentioned cutting edge limit stop. Instead, a positioning recess is provided in the area of the limit stop portion, in which a stopper of an external mounting device engages during the mounting of the blades on the supports. The two ends of the cutting edges come in contact with these stoppers when the support frame and the blades are positioned in the mounting device in order to hold the respective blade in the correct position during its fastening to the support.

### SUMMARY OF THE INVENTION

A preferred embodiment is characterized by the support frame being formed in one piece. The side portions and all supports are preferably formed from a metallic base plate. For this purpose, the required open spaces are, for example, created by laser cutting, punching or milling, followed up by a bending process which may comprise several bending steps. The support frame does not need to be assembled from a plurality of parts. The blades are preferably fastened to the supports after conclusion of the bending process, in particular by laser welding. The one-piece design of the support frame allows the manufacture of a blade unit (also referred to as a system shaver cutting unit) that is made entirely of metal and thus has significantly improved recyclability. In addition, this results in a novel, visually high-quality design.

For exact positioning of the blades, it is sufficient to place them on the head portions of the support and press the lateral ends of the cutting edges either against the limit stop portions formed in the support frame or against the stoppers of the mounting device until the laser welding process is complete. The accuracy of the positioning of the blades in the first embodiment thus depends primarily on the accuracy of the limit stop portions, which can be adjusted by a precise but easily controlled bending process. In this respect, the manufacture of the second embodiment is simpler, in which a positioning recess is provided in the area of the limit stop portion, in which a stop engages during manufacture. In this case, the accuracy of the positioning of the cutting edges depends on the precise alignment of the support frame in a mounting device.

According to a modified embodiment, the cutting edge located in the open space between the supports projects beyond the head portion by a predetermined protrusion dimension, so that the cutting edge is located at a predetermined dimension above or below the shaving plane defined by the support frame. Preferably, this dimension can be selected differently for the individual blades, as is usual for multi-blade razors. The respective dimension can be determined with high repeatability through the positioning of the respective cutting edge limit stop.

A further developed embodiment of the blade unit has a slide strip recess which is mounted in the support frame behind the blades as viewed in the shaving direction. A slide strip is mounted in the slide strip recess, the longitudinal axis of which slide strip runs parallel to the cutting edges. The slide strip preferably comprises a water-soluble material which is applied to the skin after contact of the blade during shaving.

A further improved embodiment has a pretensioner recess in the support frame, which is arranged in front of the blades in the shaving direction. A skin pretensioning strip can be positioned in the pretensioner recess, the longitudinal axis of which strip then extends parallel to the cutting edges. Such skin pretensioning strips are known per se. After assembly, the surface of the skin pretensioner strip lies in the shaving plane or alternatively codetermines it.

According to a modified embodiment, the skin pretensioner strip itself can be part of the razor handle so that the skin pretensioner strip engages in the pretensioner recess during coupling between the razor handle and the blade unit. In this way, a later recycling of an all-metal blade unit is further facilitated since the skin pretensioner strip, which is made of plastic, is already removed from the blade unit when it is disengaged.

A preferred embodiment comprises a trimmer blade support, which is preferably formed as one piece with the support frame and is at an angle to the other supports. A trimmer blade is fastened to the trimmer blade support, wherein the cutting edge of the trimmer blade does not point to the shaving plane but rather is approximately perpendicular to this plane. The longitudinal axis of the cutting edge of the trimmer blade does however simultaneously run parallel to the longitudinal axes of the other blades. The trimmer blade serves the user, for example, for shaving small areas of skin which are not reached by the main blades due to the surface extension of the blade unit.

Preferably, the support frame comprises fastening elements for coupling a handle and/or a housing unit of the wet shaver. Particularly preferably, the fastening elements are also formed as one piece with the support frame, for example in the form of tabs, hooks, detents or the like, which are preferably resiliently formed in order to be able to engage in complementary elements on the handle and/or the housing unit. Particularly preferably, the support frame and the fastening elements for coupling the handle are made entirely of metal.

The invention further provides a wet shaver comprising at least one handle and a blade unit directly or indirectly fastened thereto according to the previously described embodiments.

### DESCRIPTION OF THE DRAWINGS

Further advantages and details of the invention will be apparent from the following description of a preferred embodiment, with reference to the drawing. Wherein:

FIG. 1 shows a perspective view from the rear of a first embodiment of a blade unit according to the invention;

FIG. 2 shows a perspective cross-sectional view of the blade unit according to FIG. 1, with a support frame;

FIG. 3 shows a top view of a base plate of the support frame before a bending operation;

FIG. 4 shows a detailed perspective view of a support with a cutting edge limit stop;

FIG. 5 shows a detailed perspective view of the support according to FIG. 4 with inserted blade;

FIG. 6 shows a side view of the support according to FIG. 5;

FIG. 7 shows a side cross-sectional view of a second embodiment of the blade unit;

FIG. 8 shows a detailed view of a limit stop portion of a cutting edge in the blade unit according to FIG. 7;

FIG. 9 shows a side cross-sectional view of the blade unit according to FIG. 7 in a mounting device;

FIG. 10 shows a perspective view of a wet shaver with the blade unit.

### DETAILED DESCRIPTION OF THE INVENTION

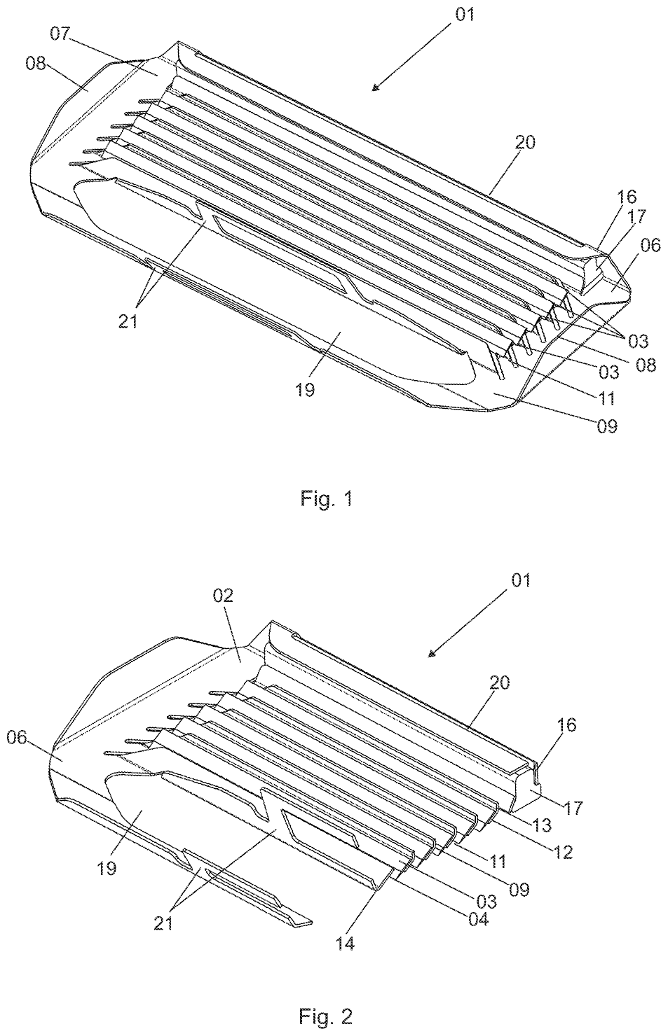

FIG. 1 shows a first embodiment of a blade unit 01 according to the invention in a rear perspective view. FIG. 2 shows a cross-sectional view of this unit. The blade unit 01 is conceived for a wet razor and is preferably configured as an exchangeable unit, so that at least one handle of the wet razor (not shown) can be used several times, whereas the blade unit is exchanged in case of wear as soon as its blades are blunted.

The blade unit 01 has a support frame 02, which has an inner face and an outer face facing a shaving plane. The views in FIG. 1 and FIG. 2 look at the rear side of the blade unit 01, so that the inner face of the support frame 02 is visible. A plurality of elongate blades 03 are arranged in the support frame 02, which blades respectively have a cutting edge 04 which extends transversely with respect to a shaving direction. In the example shown, five blades 03 are used as main blades, so that one speaks of a 5-blade razer. In modified embodiments, fewer or also more blades can be arranged in the blade unit.

The support frame 02 has a base plate 06 which comprises two opposing side portions 07. In the illustrated embodiment, the side portions 07 have rearwardly angled side protection plates 08 that laterally shield off the interior of the blade unit 01. In modified embodiments, the side portions can be configured without the angled side plates. This results in increased flexibility of the base plate so that it can better adapt to uneven parts of the body.

A plurality of parallel supports 09 run between the side portions 07, with an open space 11 remaining between each of the parallel supports. Each support 09 comprises a head portion 12 and a base portion 13 angled towards the head portion. Each of the blades 03 is mounted to the inside of the head portion 12 of the associated support 09, so that the cutting edge 04 lies in the open space 11 between two adjacent supports 09 or alternatively, in the case of the foremost blade in the shaving direction, lies in the open space between its support and a blade guard 14, which extends in front of the foremost blade parallel to its cutting edge. The cutting edges 04 are oriented towards the outside of the support frame 02 so that they come into contact with the hairs to be cut during shaving. Preferably, the cutting edge 04 of the foremost blade is set back slightly inward relative to the blade guard 14 in order to avoid shaving injuries. The thereinafter following blades preferably rise stepwise in the so-called protrusion, which can also be a protrusion or exposure. Other arrangements, for example with changing protrusion dimensions, are also possible.

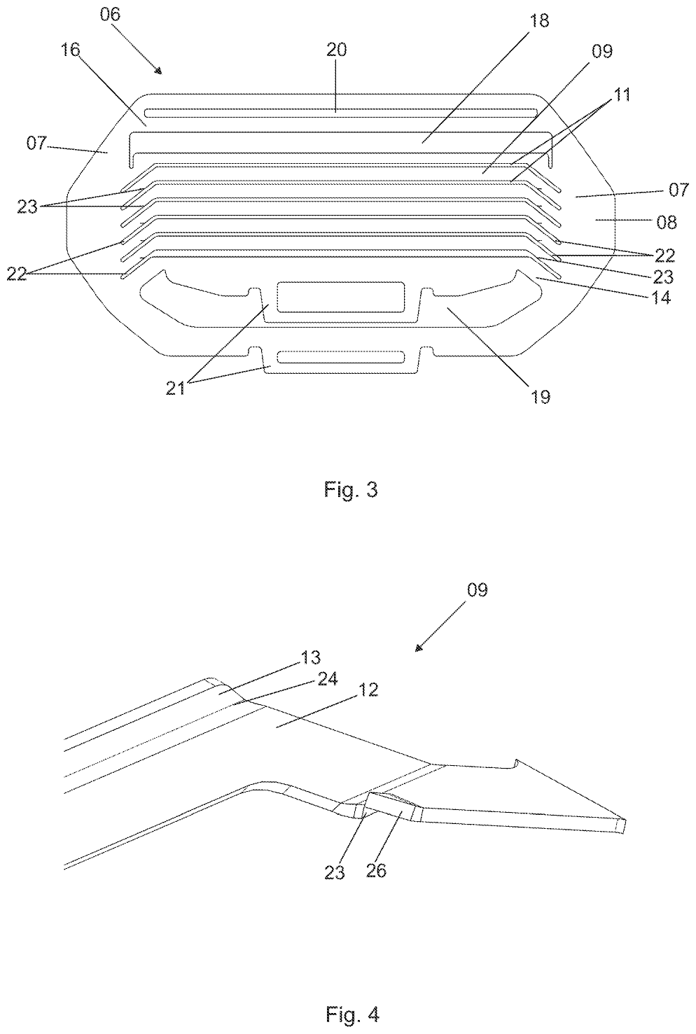

The rear side of the support frame 02 in the shaving direction is doubly angled inwards. In so doing, this forms a rear guard 16 which also serves to hold a slide strip 17. The slide strip 17 is thus located behind the last blade 03 in the shaving direction. The upper side of the slide strip 17 projects through a slide strip recess 18 (FIG. 3) in the base plate 06 to contact the skin during shaving.

The front side of the support frame 02 in the shaving direction has a pretensioner recess 19 in which a skin pretensioner strip (also referred to as a foam edge) can be positioned (not shown). In addition, a plurality of fastening elements 21 are formed as one piece in this front portion of the support frame 02, which can be coupled to a handle and/or housing unit (not shown) to bear the blade unit 01.

A trimmer blade recess 20 is provided at the rear end of the support frame 02 in the shaving direction, in which recess a trimmer blade (not shown) can be inserted if required. The cutting edge of the trimmer blade would then minimally protrude from the trimmer blade recess 20.

FIG. 3 shows a top view of the base plate 06 of the support frame 02 prior to a bending operation, which bending operation may comprise several bending steps. The base plate 06 is preferably made of metal, in particular stainless steel. It is evident that all the necessary recesses are made in the base plate 06 before bending, which recesses then form the open spaces 11, the slide strip recess 18 and the pretensioner recess 19. It is likewise clearly recognizable in this illustration that the open spaces 11, respectively starting at the side portions 07 of the support frame 02, run at an acute angle to the cutting edge located in the open space 11 in a respective limit stop portion 22. The axis of the open space between the adjacent supports 09 thus tilts in the limit stop portion, for example, by ±45°. In addition, a notch 23 is provided in each limit stop portion 22 parallel to the cutting edge 04 of the blade 03 to be inserted, the function of which notch will be explained below.

FIG. 4 shows a detailed perspective view of the support 09. During the bending process, the head portion 12 and the base portion 13 are angled relative to each other along a bending line 24 so that they, for example, form an angle of between 90° and 160°. This bending serves primarily to increase the rigidity of the support 09 so that no bending occurs in the longitudinal direction of the strip-shaped support 09 during shaving. At the limit stop portion 22, a cutting edge limit stop 26 is bent out of the plane of the limit stop portion 22 along the notch 23 in the manner of a projection. The substantially triangular cutting edge limit stop 26 is located at a portion of the support 09 running at an acute angle to the cutting edge 04 and rises into the interior of the blade unit 01. The side edge of the cutting edge limit stop 26, which results from the notch 23, runs parallel with the cutting edge 04 of the blade 03 to be positioned there.

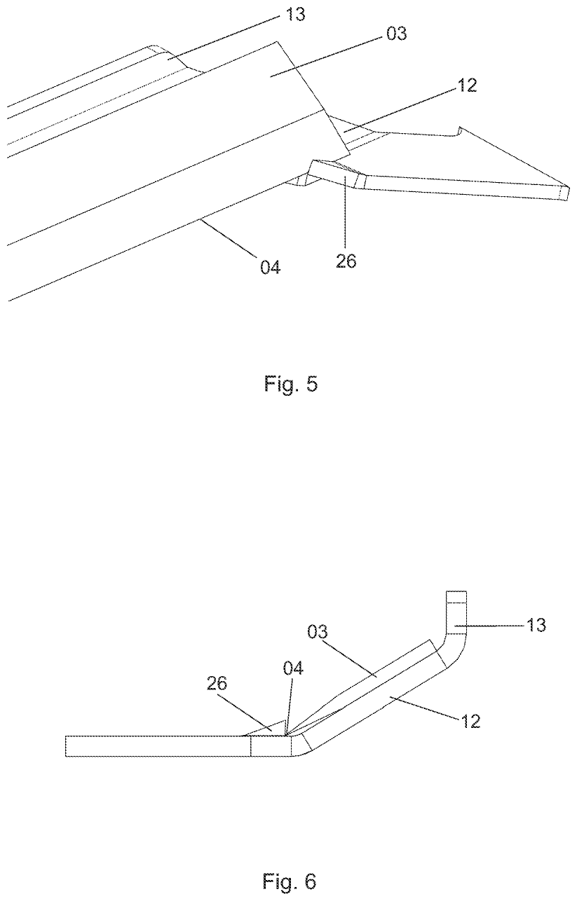

FIG. 5 shows a detailed perspective view of the support 09 with the blade 03 fastened to it. It can be seen that the end of the cutting edge 04 comes into contact with the cutting edge limit stop 26, whereby the position of the cutting edge 04 is precisely determined, independently of the transverse expansion of the blade 03, which can vary due to the manufacturing process. This ensures that the cutting edge 04 of each individual blade 03 is precisely at the desired height or alternatively at the desired distance from the shaving plane. The shaving plane can be regarded as the surface which is tangent to the blade guard 14 at the front in the shaving direction and the slide strip 17 at the rear in the shaving direction.

FIG. 6 shows a side view of the support 09 with the blade 03 fastened thereto. It is readily apparent that the blade 03 is fastened to the head portion 12 on the inside of the support 09. The projection or elevation of the cutting edge limit stop 26 corresponds approximately to the thickness of the blade 03.

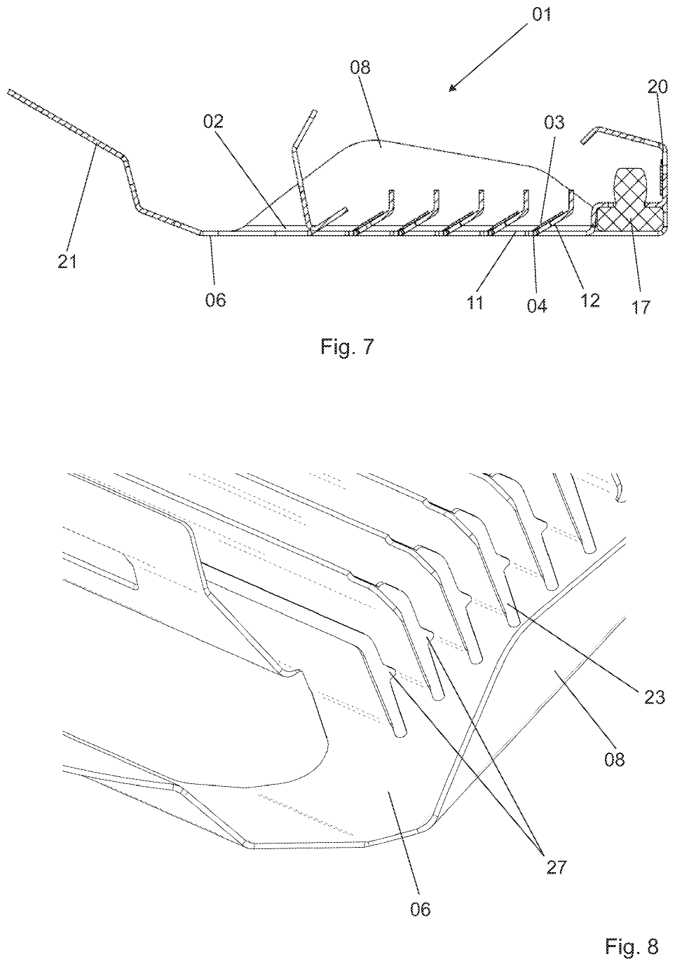

FIG. 7 shows a lateral cross-sectional view of a second embodiment of the blade unit 01. FIG. 8 shows a detailed view of this embodiment, wherein the blades are not shown for reasons of clarity. In this case, too, a total of five blades 03 are respectively arranged on the inside of the head portion 12 of the associated support 09, so that the cutting edge 04 lies in the open space 11. In this embodiment, the notched cutting edge limit stop is missing. In order to nevertheless position the cutting edges of the five main blades precisely in the shaving plane or alternatively by the desired offset outside this plane, a positioning recess 27 is respectively provided in the base plate 06 of the support frame 02 in the area of the limit stop portion 22.

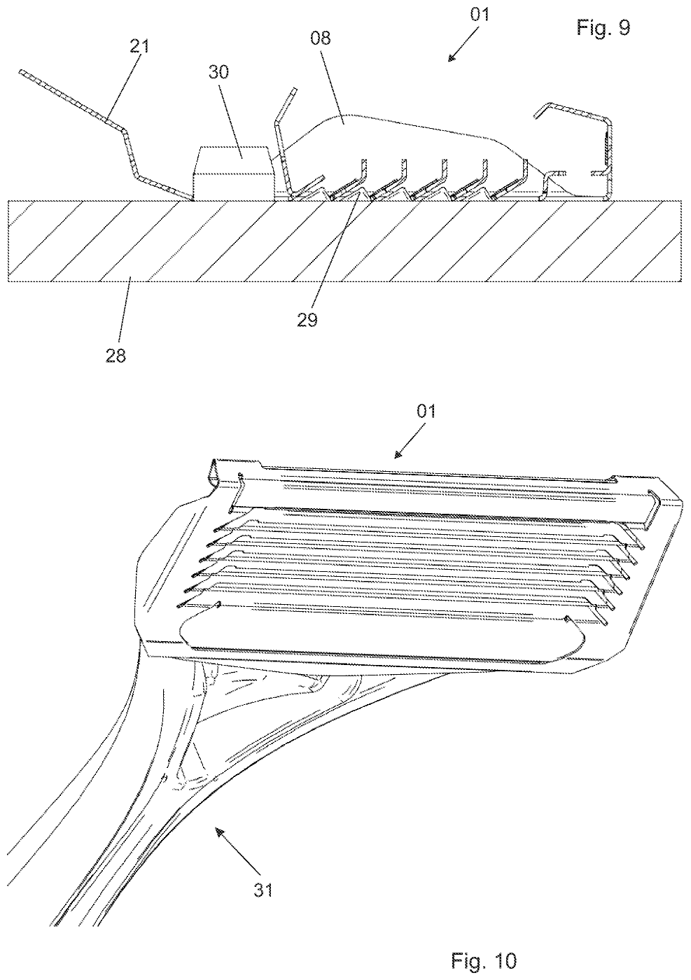

FIG. 9 shows a lateral cross-sectional view of a mounting device 28 with blade unit 01 fastened during the manufacturing process. The mounting device comprises a plurality of stops 29, which respectively engage in the positioning recess 27 and which the cutting edges of the individual blades come into contact with. Two position bollards 30, which engage in the unfilled pretensioner recess 19, ensure basic alignment of the support frame 02 on the mounting device 28.

FIG. 10 shows a perspective view of a razor equipped with the blade unit 01 and a handle 31. It can be seen that the blade unit is mounted directly to the handle 31 of the razor by means of its fastening elements.

1. A blade unit for a wet razor comprising a support frame, which has an inner face and an outer face oriented towards a shaving plane and in which a plurality of elongate blades are arranged, which respectively have a cutting edge which extends transversely with respect to a shaving direction, wherein:
the support frame has two opposing side portions, which extend transversely with respect to the cutting edges of the blades;
a plurality of mutually parallel supports run between the side portions, between which an open space respectively remains and which supports each have a head portion and a thereto angled base portion;
one of the blades is respectively mounted to the inside of the head portion of one of the supports, so that the cutting edge lies in the open space and extends in the direction of the outside;
the open spaces respectively run starting at the side portions of the support frame in a limit stop portion at an angle to the cutting edge.

2. The blade unit according to claim 1, wherein the support frame is formed in one piece from a base plate, which is preferably made of metal and has been subjected to one or more bending steps.

3. The blade unit according to claim 1, wherein the two opposing side portions of the support frame are flat.

4. The blade unit according to claim 1, wherein the cutting edges of the blades respectively come in contact with a respective cutting edge limit stop at their two ends in the associated limit stop portion, wherein the cutting edge limit stop rises into the interior of the blade unit at a portion of the support extending at an angle to the cutting edge.

5. The blade unit according to claim 1, wherein a positioning recess is provided in each of the limit stop portions, in which a stopper of a mounting device can engage during the assembly of the blade unit.

6. The blade unit according to claim 1, wherein the cutting edge located in the open space protrudes beyond the head portion of the support by a predetermined projection dimension.

7. The blade unit according to claim 1, wherein characterized in that a slide strip recess is mounted in the support frame behind the blades in the shaving direction, in which recess a slide strip is mounted.

8. The blade unit according to claim 1, wherein in the shaving direction, in front of the blades, a pretensioner recess, in which a skin pretensioning strip can be positioned, is fitted in the support frame.

9. The blade unit according to claim 1, wherein in the shaving direction, at the rear end of the support frame, a trimmer blade recess is arranged, in which a trimmer blade is arranged.

10. The blade unit according to claim 1, wherein the blades are welded to the respective head portion of the support, preferably, in each case, by a plurality of laser welding points.

11. The blade unit according to claim 1, wherein fastening elements are formed as one piece on the support frame and can be coupled to a handle and/or a housing unit.

12. The blade unit according to claim 11, wherein the fastening elements are formed as resilient tabs, hooks, detents.

13. A wet shaver comprising a handle and a blade unit directly or indirectly fastened thereto according to claim 1.
